(19) United States
(12) Patent Application Publication
(10) Pub. No.: US 2006/0070055 A1
(43) Pub. Date: Mar. 30, 2006

(54) Method of updating printer firmware and printing device employing the method

(76) Inventors: Leonard B. Hodder, Toronto (CA); Alan Pak-Lun Ho, Unionville (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/949,532

(22) Filed: Sep. 24, 2004

(51) Int. Cl. G06F 9/44

(52) U.S. Cl. 717/168

(57) ABSTRACT

A method of updating resident firmware in a printer via a printer interface holding updated printer firmware includes automatically sending a request for printer hardware and firmware information to the printer. Printer hardware and firmware information received in response to the request is examined to determine if the updated printer firmware is compatible with the printer. If the updated printer firmware is not compatible with the printer, the updating is terminated. If the updated printer firmware is compatible with the printer, the updated printer firmware is automatically transmitted to the printer for storage therein.

### FIELD OF THE INVENTION

The present invention relates generally to printing devices and in particular, to a method of updating firmware in a printer using a printer interface and to a printing device employing the method.

### BACKGROUND OF THE INVENTION

Stand-alone electronic cash registers including payment card readers and receipt printers have been used for years in stores, retail outlets and service outlets to facilitate the completion of cash, cheque, credit card or debit card transactions for the purchase of goods and/or services. With the advent of sophisticated and inexpensive computing equipment, input devices and secure communication networks, point-of-sale (POS) stations have become an increasingly popular alternative.

POS stations typically include a host device and a plurality of interchangeable peripherals connected to the host device. The host device and peripherals are easily integrated allowing the configuration of POS stations to be modified to meet changing needs. This has been another factor leading to their widespread acceptance. The host device is commonly in the form of a personal computer. The peripherals often include a keyboard, a display screen, a cash drawer, a printing device, a payment card reader and a barcode reader. In some cases, a touch-sensitive display screen is used instead of separate keyboard and display screen peripherals.

As is well known, the host device communicates with the peripherals and executes software to allow product and/or service transactions to be completed. When payment is effected using a debit or credit card, the host device establishes a connection to the appropriate financial institution over an information network so that approval for the transaction may be obtained. Upon completion of any transaction, the host device creates and transmits a print job to the printing device causing the printing device to generate a transaction receipt and a possibly signing receipt, if payment is made using a credit card.

In larger stores, retail outlets and service outlets, POS stations are typically linked via a local area network and communicate with a backend computing device that maintains a database for transaction, inventory, accounting, sales, tax, etc. information. Transaction data received by each of the POS stations is conveyed to the backend computing device for storage in the database allowing all transaction data to be stored in a common location. Collectively storing all transaction data in one common location allows retailers to track, account for and maintain inventory, collected taxes and pricing information. Also, by linking the POS stations, updates relating to sales on products and/or services, tax, etc. can be communicated to each POS station over the local area network avoiding the need to update the POS stations one at a time.

Printing devices commonly used in POS stations comprise a printer having a slot for receiving a separate printer interface that controls communications between the host device and the printer. The printer interface is primarily selected based on the communication protocol used by the host device thereby to ensure hardware compatibility between the host device and the printer. For example, hardware compatibility may be achieved by installing a serial, parallel, Ethernet or USB interface into the printer slot. As the printer interface can be readily changed, the printer is not limited for use with any particular communication protocol but rather can be used in many different communication protocol environments simply by replacing the printer interface. The printer interface may also be selected to enhance functionality of the printer such as by adding supplemental fonts or by emulating one or more other printer models.

The printer interface and the printer are typically preloaded with firmware although the printing device may receive updated printer firmware from the host device to replace or patch the existing printer firmware. Updated printer firmware received from the host device by the printer interface is in turn conveyed to the printer for storage therein.

The printer firmware typically includes a boot file, a main firmware file and one or more font files. The boot file is executed by the printer during initialization to place the printer into a ready operating state. The main firmware and font files are executed during normal operation of the printer to allow the printer to respond to print commands received from the host device via the printer interface so that appropriate transaction receipts can be printed. The font file typically contains glyph or shape data for each character in the font file character sets.

In many instances it is desired to update the printer firmware stored in the printer to allow the printing device to print receipts in different formats and/or languages, to support additional functionality and/or to enhance printer performance. As a result, a number of techniques for updating printer firmware have been considered. For example, U.S. Pat. No. 5,647,056 to Barrett et al. discloses a method and apparatus for managing access to a network peripheral such as a printer. A network expansion board receives status requests for information such as error codes, number of pages printed, toner status etc., from network devices and passes them to the printer. The network expansion board also transmits printer configuration codes to the network devices. The firmware of the network expansion boards is updated via the network.

U.S. Pat. No. 6,467,087 to Yang discloses a method for updating printer firmware. Printer firmware is downloaded to a network interface in response to a user request. The upgraded printer firmware can be executed upon power up or after execution of a general function.

U.S. Pat. No. 6,607,314 to McCannon et al. discloses an apparatus and method for updating a software routine on a printer. The printer automatically retrieves an updated driver from a network device. The printer also determines when it is running an old version of the driver and an updated version is available and generates a notification.

U.S. patent application Publication No. 2002/0170049 to Suyehira discloses a method and apparatus for upgrading programming of a computer apparatus such as a printer. The printer checks an OEM server for firmware updates, and downloads updated firmware if a newer version of the firmware is available.

U.S. patent application Publication No. 2003/0035132 to Tomita discloses an apparatus capable of executing a rewrite in its firmware. If a firmware update on the printer is being executed, a notice is sent to the printer user. In response to this information, the user may decide whether to proceed with sending a print job or take another action. Firmware is transmitted and received by the printer via serial interface units.

Although the above references describe printer firmware update methods, as will be appreciated, prior to updating printer firmware, it is desired to ensure that the updated printer firmware to be loaded into the printer is compatible with and suitable for the printer. Loading non-compatible, non-suitable and/or unnecessary updated printer firmware can be problematic.

It is therefore an object of the present invention to provide a novel method of updating firmware in a printer using a printer interface and a printing device employing the method.

### SUMMARY OF THE INVENTION

Accordingly, in one aspect of the present invention there is provided a method of updating firmware in a printer using a printer interface. During the method, at least one query is sent to the printer requesting information concerning the resident printer firmware stored therein. In response to the query, a determination is made as to whether the resident printer firmware is to be updated. If the resident printer firmware is to be updated, updated printer firmware is automatically transmitted to the printer for storage therein.

During the determining, a check is also made to determine if the current resident printer firmware is designated for updating with the updated printer firmware. The at least one query requests printer hardware and firmware identification information and wherein during the determining, the printer interface compares received printer hardware and firmware identification information with information stored therein to detect coincidence indicating compatibility. The printer hardware and firmware information includes printer model number, firmware version and boot code version information.

According to another aspect of the present invention there is provided a method of updating resident firmware in a printer via a printer interface holding updated printer firmware. During the method, a request for printer hardware and firmware information is automatically sent to the printer. Printer hardware and firmware information received in response to the request is examined to determine if the updated printer firmware is compatible with the printer. If the updated printer firmware is not compatible with the printer, the updating is terminated. If the updated printer firmware is compatible with the printer, the updated printer firmware is automatically transmitted to the printer for storage therein.

According to yet another aspect of the present invention there is provided a printing device comprising a printer having a processing unit, memory storing printer firmware executed by the processing unit and a printer control mechanism responsive to the processing unit and printing information on a medium. A printer interface is coupled to the printer and includes a processing unit and memory storing a printer firmware update routine. The printer firmware update routine is automatically executed when the memory of the printer interface holds updated printer firmware to effect loading of the updated printer firmware to the printer.

The printer firmware update method provides advantages in that printer firmware in the printer is automatically updated by the printer interface when compatible and appropriate updated printer firmware is stored in the printer interface. Since updated printer firmware is checked for both hardware and firmware compatibility and also to determine whether the updated printer firmware is designated to be used to update the resident printer firmware in the printer, printer firmware updates are made seamlessly and without creating operational problems.

### BRIEF DESCRIPTION OF THE DRAWINGS

Embodiments will now be described more fully with reference to the accompanying drawings in which:

FIG. 1 is a schematic block diagram of a point-of-sale station including a printing device;

FIG. 2 is a schematic block diagram of the printing device of FIG. 1;

FIG. 3 is a flowchart showing the general steps performed by the printing device during printer firmware updating;

FIG. 4 is a flowchart showing the steps performed by the printing device during printer firmware compatibility determination;

FIG. 5 is a flowchart showing the steps performed by the printing device during printer firmware transmission; and

FIG. 6 is a flowchart showing the steps performed by the printing device following an interruption that occurred during printer firmware transmission.

### DETAILED DESCRIPTION OF THE EMBODIMENTS

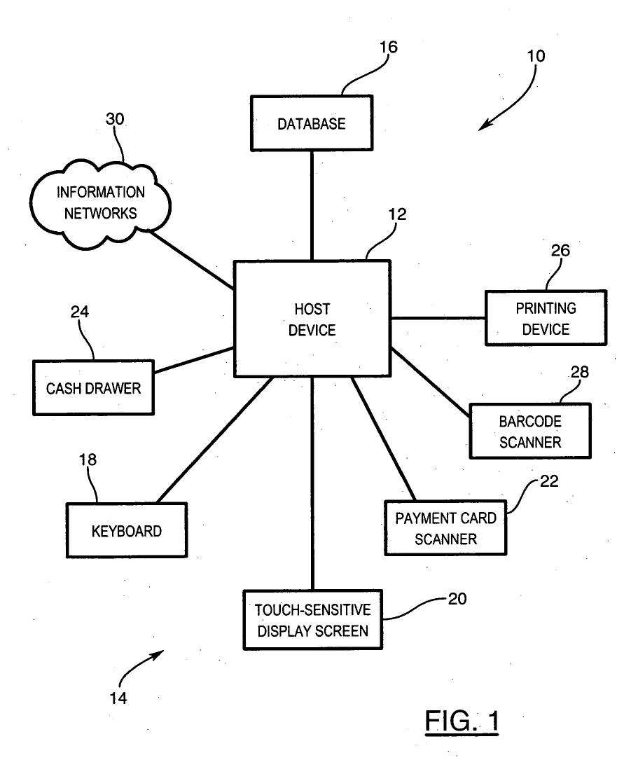

Turning now to FIG. 1, a point-of-sale (POS) station is shown and is generally identified by reference numeral 10. As can be seen, POS station 10 includes a microprocessor-based host device 12 in the form of a personal computer that communicates with a plurality of peripherals generally identified by reference numeral 14 and with a database 16 storing transaction, inventory, pricing, tax and accounting information. In this example, peripherals 14 include a keyboard 18, a touch-sensitive display screen 20, a payment card scanner 22, a cash drawer 24, a printing device 26 and a barcode scanner 28. Host device 12 also communicates with financial institutions (not shown) such as banks and credit card companies over one or more information networks generally identified by reference numeral 30.

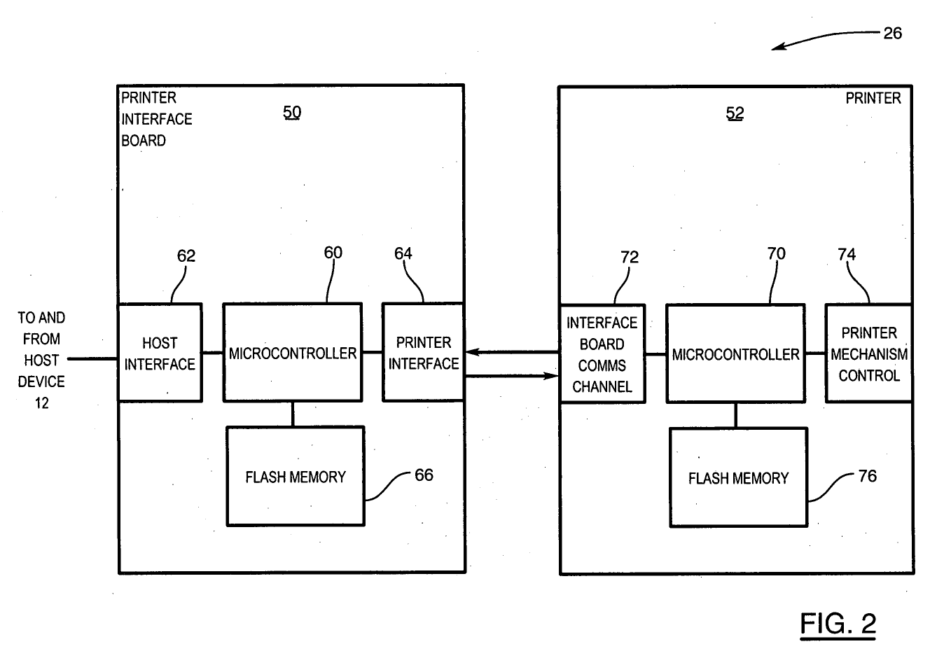

Printing device 26 is best illustrated in FIG. 2 and includes a printer interface 50 and a printer 52. Printer interface 50 comprises a microcontroller 60, a host interface board 62, a printer interface board 64 and non-volatile flash memory 66. Printer 52 comprises a microcontroller 70, a communications channel interface board 72, a printer control mechanism 74 and non-volatile flash memory 76. For example, the printer interface 50 may be of the type sold by EPSON under model No. UB-EML and the printer 52 may be of the type sold by EPSON under model No. TM-U200.

The non-volatile memory 66 stores printer interface firmware that is executed by the microcontroller 60 during initialization and operation of the printing device 26 to permit communications between the host device 12 and the printer 52 and optionally, to enhance operation of the printer by storing supplemental font files that allow the printer to print characters of different style and/or size and/or emulation files that allow the printer to emulate one or more other printer models.

The non-volatile memory 76 stores printer firmware that is executed by the microcontroller 70 during initialization and operation of the printing device 26 to allow the printer 52 to respond to commands generated by the host device 12 and print appropriate receipts when a transaction is completed. In this particular embodiment, the printer firmware includes a boot file, a main firmware file and a font file. The firmware also includes printer hardware and firmware identification information to enable the printer interface 50 to determine the type of printer and the status of the resident printer firmware. For example, the printer hardware and firmware identification information includes the version string of the main firmware file, the version string of the boot file, the version of the font file and the printer model identification number (ID). The printer model ID is a single data byte, the value of which is unique to the printer 52.

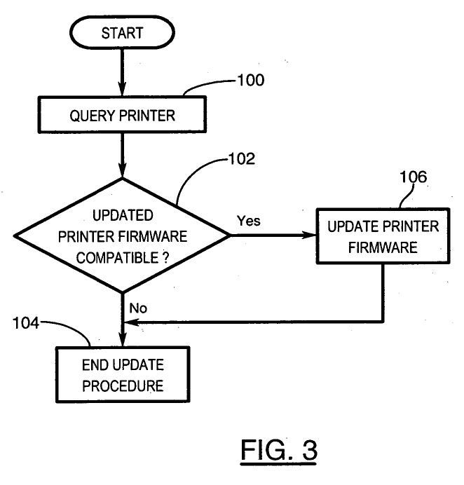

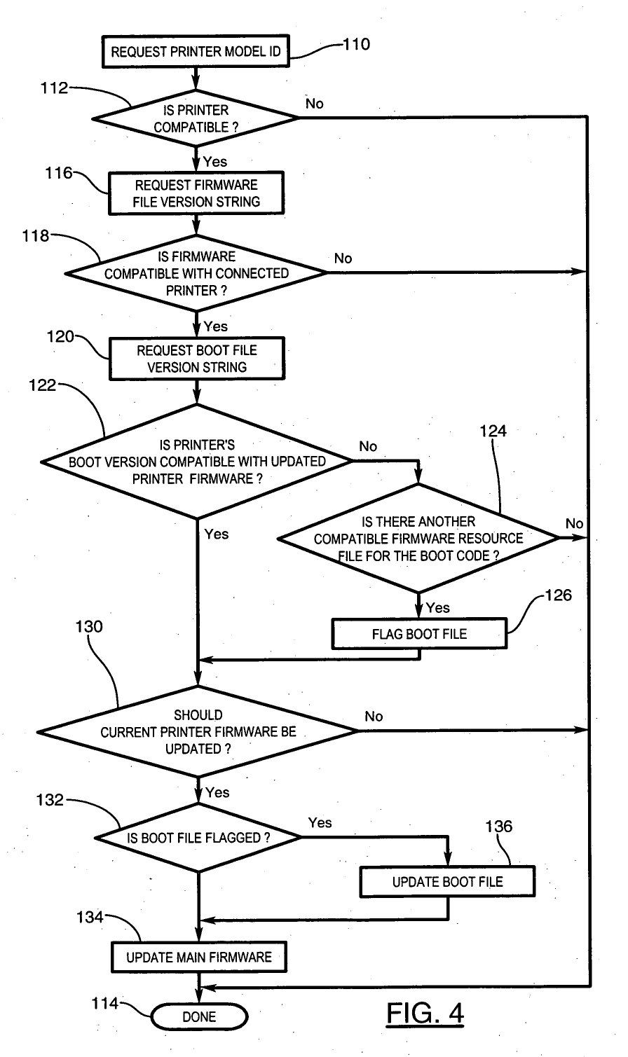

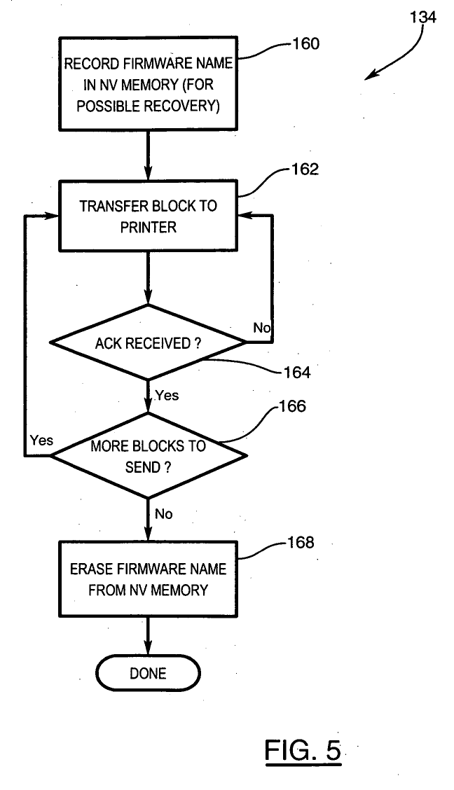

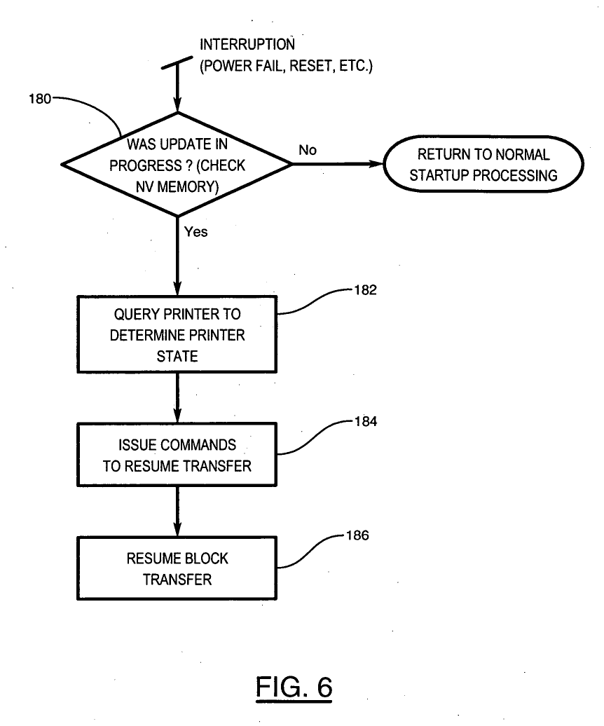

As mentioned above, in some instances it is desired to update the printer firmware stored in the non-volatile memory 76. Printer firmware updates can be initiated by the host device 12 or by the printer interface 50, if the printer 52 is fitted with a printer interface 50 that is loaded with updated printer firmware. The manner by which printer firmware is updated will now be described with particular reference to FIGS. 3 to 6.

When a printer firmware update is initiated by the host device 12, the host device transmits the updated printer firmware to the printer interface 50 which in turn stores the updated printer firmware in the non-volatile memory 66. Preferably, the printer firmware is transmitted to the printer interface 50 by the host device 12 in the manner disclosed in Applicants' co-pending U.S. patent application entitled “Method And System Of Transferring Firmware From A Host Device To A Printing Device”, filed on even date herewith and assigned to the present assignee, the content of which is incorporated by reference.

In the present example, updated printer firmware stored in the non-volatile memory 66, whether received from the host device 12 or preloaded, includes a main firmware file and a boot file and optionally one or more font files. The main firmware and boot files include printer and firmware identification and compatibility information. The printer and firmware identification and compatibility information includes a main firmware file version string, a firmware type identifier, a printer version identifier, a printer model identification number (ID), a boot model ID, a boot version string, a boot version identifier, a boot version string address and a printer firmware version string.

The main firmware file version string is a character string identifying the version of the main firmware file in the updated printer firmware. The firmware type identifier identifies the types of files that are included in the updated printer firmware i.e. main firmware file, boot file, font file etc. The printer version identifier identifies the version(s) of printer firmware that the updated printer firmware is compatible with. The printer model ID identifies the model(s) of printer(s) that the updated printer firmware is compatible with. The boot model ID also identifies the model(s) of printer(s) that the updated printer firmware is compatible with. The boot version string is a character string identifying the version of the boot file in the updated printer firmware. The boot version identifier is a unique number which represents the boot file version(s) the updated printer firmware is compatible with. The boot version string address identifies the address in the non-volatile memory 76 where the boot file version string is located. The printer firmware version string includes a list of compatible printer firmware version strings that are to be updated using the updated printer firmware.

When the printer interface 50 stores updated printer firmware either as a result of a host device download or a preload, the printer interface 50 automatically initiates a printer firmware update procedure stored in the non-volatile memory 66. During the printer firmware update procedure, the printer interface 50 queries the printer 52 to determine if the updated printer firmware is compatible with the printer 52 (steps 100 and 102). If the updated printer firmware is not compatible with the printer 52, the printer firmware is not updated and the printer firmware update procedure is terminated (step 104). If the updated printer firmware is compatible with the printer 52, the printer is automatically updated with the updated printer firmware (step 106). Upon completion of the printer firmware update, the printer firmware update procedure is terminated (step 104).

During updated printer firmware compatibility determination at steps 100 and 102, the microcontroller 60 in the printer interface 50 sends an initial query to the printer 52 requesting the model number of the printer 52 (step 110). The microcontroller 70 in response to this query retrieves the printer model ID from the non-volatile memory 76 and transmits the printer model ID to the printer interface 50. Upon receipt, the microcontroller 60 compares the received printer model ID with the printer model ID in the printer and firmware identification and compatibility information in the updated printer firmware to determine coincidence (step 112). If the result of the comparison is negative, indicating that the updated printer firmware is not compatible with the printer 52, the printer firmware update procedure is terminated (step 114).

If the result of the comparison is positive at step 112, the microcontroller 60 sends another query to the printer 52 requesting the version string of the firmware file of the current resident printer firmware (step 116). The microcontroller 70 in response to this query retrieves the firmware file version string from the resident printer firmware and transmits it to the printer interface 50. Upon receipt, the microcontroller 60 compares the received firmware file version string with the printer version identifier in the printer and firmware identification and compatibility information in the updated printer firmware again to determine coincidence (step 118). If the result of the comparison is negative, indicating that the updated printer firmware is not compatible with the printer 52, the printer firmware update procedure is terminated (step 114).

If the result of the comparison is positive at step 118, the microcontroller 60 sends yet another query to the printer 52 requesting the version string of the boot file of the current resident printer firmware (step 120). The microcontroller 70 in response to this query retrieves the boot file version string from the resident printer firmware and transmits it to the printer interface 50. Upon receipt, the microcontroller 60 compares the received boot file version string with the boot version identifier in the printer and firmware identification and compatibility information in the updated printer firmware to determine coincidence (step 122). If the result of the comparison is negative, the printer interface 50 checks the non-volatile memory 66 to determine if it holds other updated printer firmware to be loaded into the printer 52 that includes a boot file that is compatible with both the current resident printer firmware and the updated printer firmware (step 124). If not, the printer firmware update procedure is terminated (step 114). If so, the updated printer firmware including the compatible boot file is flagged (step 126).

At step 122, if the result of the comparison is positive or if updated printer boot firmware is flagged at step 126, the microcontroller 60 compares the printer's current hardware and firmware identification information with the updated printer firmware's printer and firmware identification and compatibility information to determine if the current resident printer firmware should be updated (step 130).

If the current printer firmware is not identified in the compatibility list in the updated printer firmware, the printer firmware update procedure is terminated (step 114). If the current resident printer firmware is identified in compatibility list in the printer firmware, a check is made to determine if updated printer firmware including a compatible boot file has been flagged (step 132). If updated printer firmware including a compatible boot file has not been flagged, the printer interface 50 transmits the updated printer firmware to the printer 52 thereby to update the printer firmware and complete the printer firmware update procedure (step 134). If at step 132, flagged updated printer boot firmware is detected, the boot file in the flagged updated printer firmware is firstly transmitted to the printer 52 to update its boot file (step 136) prior to transmitting the updated printer firmware to the printer 52 at step 134. With the printer firmware updated, the printer firmware information stored in the non-volatile memory 76 is updated so that the updated printer firmware information is used during the next printer firmware upgrade.

At step 134, when updated printer firmware is to be transmitted from the printer interface 50 to the printer 52, the microcontroller 60 initially records the name of the current resident printer firmware in the non-volatile memory 66 (step 160). The microcontroller 60 then partitions the updated printer firmware into data blocks for transmission to the printer 52. The microcontroller 60 then queues the data blocks and sends one of the data blocks to the printer 52 (step 162). Upon receipt of the data block, the microcontroller 70 stores the data block in the non-volatile memory 76 and sends an acknowledgement back to the printer interface 50 confirming receipt of the data block (step 164).

When the acknowledgement is received, the microcontroller 60 checks the queue to determine if one or more data blocks in the queue exist (step 166). If one or more data blocks exist, another data block is sent to the printer 52. Steps 162 to 166 are performed until all of the data blocks in the queue have been sent to the printer 52 and acknowledged. Once the complete updated printer firmware has been transferred to the printer 52 and stored in the non-volatile memory 76, the microcontroller 60 erases the name of the old printer firmware that was recorded in the non-volatile memory 66 at step 160 (step 168).

If after sending a data block an acknowledgement is not received by the microcontroller 60 within a threshold period of time (step 166), the microcontroller 60 resends the data block (step 162) and again awaits receipt of an acknowledgement. As will be appreciated, the microcontroller 60 will break a data block resending loop if a threshold number of resends or some other similar condition is reached.

If during updating of the printer firmware an interruption occurs either due to a power interruption, a printing device reset or the like, upon restoration, the microcontroller 60 checks to determine if a printer firmware update procedure was in progress prior to the interruption (step 180). If a printer firmware update procedure was in progress, the microcontroller 60 sends a query to the printer 52 requesting its status (step 182). If the status of the printer 52 indicates it is operational (step 184), the microcontroller 60 automatically recommences the printer firmware update procedure (step 186).

If desired, during updated printer firmware compatibility determination, if the version of the boot file of the updated printer firmware is not compatible with the current printer firmware, the steps of determining whether a compatible boot file exists in other updated printer firmware and flagging such updated printer firmware file can be omitted. In this case, if the boot file of the updated printer firmware is not compatible with the printer 52, the printer firmware update procedure is simply terminated.

In the above-described example, the updated printer firmware includes a boot file, a main firmware file and one or more font files. If desired, updated printer firmware to be loaded into the printer 52 may include a subset of these files. Also, multiple updated printer firmware may be stored by the printer interface 50 for loading into the printer 52. In this case, when a printer firmware update is to be performed, updated printer firmware is initially selected and the printer firmware update procedure is carried out. Upon completion of the printer firmware update procedure, a check is made to determine if other updated printer firmware exists. If so, another updated printer firmware is selected and the printer firmware update procedure is carried out again. This process is performed until all updated printer firmware is loaded into the printer 52. When loading multiple updated printer firmware, it may be desired to order the updated printer firmware so that the updated printer firmware is loaded into the printer 52 in a particular order i.e. boot file first, main firmware file second, font files last etc.

The updated printer firmware may include complete code to replace corresponding code loaded into the printer 52 or may include one or more patches to update existing code. With the one or more patches successfully loaded into the printer 52, the printer hardware and firmware identification information is updated to reflect the new status of the resident printer firmware stored in the non-volatile memory 76.

The updated printer firmware may be in the form of a single file including boot code, main firmware code and/or font code sections or may include separate subfiles for the boot code, main firmware code and/or font code.

Although specific reference is made to a printer used in a POS station, those of skill in the art will appreciate that this is for ease of illustration. The printer firmware update method is suitable for use in a variety of environments and with virtually any type of printer designed to accommodate a printer interface such as for example dot matrix printers, thermal printers, ink jet printers, laser printer etc.

Although embodiments have been described, those of skill in the art will appreciate that the variations and modifications may be made without departing from the spirit and scope of the invention as defined by the appended claims.

What is claimed is:

1. A method of updating firmware in a printer using a printer interface comprising:
sending at least one query to the printer requesting information concerning the resident printer firmware stored therein;
in response to the query, determining whether the resident printer firmware is to be updated; and
if the resident printer firmware is to be updated, automatically transmitting updated printer firmware to the printer.

2. The method of claim 1 wherein said at least one query requests printer firmware identification information and wherein during said determining received printer firmware identification information is examined to determine whether the updated printer firmware is compatible with said printer.

3. The method of claim 2 wherein said at least one query requests the firmware version string of the resident printer firmware, during said determining, said printer interface comparing the received firmware version string with a list of compatible firmware version strings to detect coincidence.

4. The method of claim 2 wherein said at least one query includes a second query requesting printer boot code identification information, during said determining, the printer boot code identification information received from said printer also being examined to determine whether the updated printer firmware is compatible with said printer.

5. The method of claim 4 wherein said second query requests the boot version string of the resident printer firmware, during said determining, said printer interface comparing the received boot version string with a list of compatible boot version strings to detect coincidence.

6. The method of claim 5 wherein if the received boot version string of the resident printer firmware is not in the list, examining other updated printer firmware to locate compatible boot code, if compatible boot code is located, transmitting the boot code to said printer prior to transmitting said updated printer firmware.

7. The method of claim 2 wherein during said detecting, a check is also made to determine if the resident printer firmware is designated for updating with the updated printer firmware.

8. The method of claim 2 wherein said at least one query requests printer hardware and firmware identification information and wherein during said determining, the printer interface compares the received printer hardware and firmware identification information with information stored therein to detect coincidence indicating compatibility.

9. The method of claim 8 wherein said printer hardware and firmware information includes printer model number, firmware version and boot code version information.

10. The method of claim 8 further comprising automatically recommencing said transmitting following an interruption.

11. The method of claim 10 wherein during said transmitting, said updated printer firmware is transmitted from said printer interface to said printer in data blocks.

12. The method of claim 11 wherein each successive data block is transmitted upon confirmation of receipt of the last data block sent by the printer interface.

13. The method of claim 2 wherein said updated printer firmware includes code to patch at least one file in the resident printer firmware.

14. The method of claim 13 further comprising automatically recommencing said transmitting following an interruption.

15. The method of claim 2 wherein said updated printer firmware includes at least one file to replace a corresponding file in the resident printer firmware.

16. The method of claim 15 wherein said at least one file includes at least one of a main firmware file, a boot file and a font file.

17. A method of updating resident firmware in a printer via a printer interface holding updated printer firmware comprising:
automatically sending a request for printer hardware and firmware information to said printer;
examining printer hardware and firmware information received in response to said request to determine if said updated printer firmware is compatible with said printer;
if the updated printer firmware is not compatible with said printer, terminating said updating; and
if the updated printer firmware is compatible with said printer, automatically transmitting said updated printer firmware to said printer for storage therein.

18. The method of claim 17 wherein if the updated printer firmware is compatible with said printer, determining if the resident printer firmware is designated for updating with the updated printer firmware and if not, terminating said updating.

19. The method of claim 18 wherein said printer hardware and firmware information includes printer model and firmware version information.

20. The method of claim 19 wherein said firmware version information includes firmware version and boot version strings.

21. The method of claim 19 further comprising automatically recommencing said transmitting following an interruption.

22. The method of claim 18 wherein said updated printer firmware includes code to patch at least one file in the resident printer firmware.

23. The method of claim 22 further comprising automatically recommencing said transmitting following an interruption.

24. The method of claim 18 wherein said updated printer firmware includes at least one file to replace a corresponding file in the resident printer firmware.

25. The method of claim 24 wherein said at least one file includes at least one of a main firmware file, a boot file and a font file.

26. A printing device comprising:
a printer having a processing unit, memory storing printer firmware executed by said processing unit and a printer control mechanism responsive to said processing unit and printing information on a medium; and
a printer interface is coupled to said printer and having a processing unit and memory storing a printer firmware update routine, said printer firmware update routine being automatically executed when the memory of said printer interface holds updated printer firmware to effect loading of said updated printer firmware to said printer.

27. A printing device according to claim 26 wherein during execution of said printer firmware update routine, said processor requests information from said printer to determine whether the updated printer firmware is compatible with said printer, loading of said updated printer firmware only being effected if said updated printer firmware is compatible with said printer.

28. A printing device according to claim 27 wherein during execution of said printer firmware update routine, said processor further checks the updated printer firmware to determine if the updated printer firmware is designated to update the printer firmware stored in the printer memory.

29. A printing device according to claim 28 wherein the requested information includes printer hardware and firmware identification information.

30. A printing device according to claim 29 wherein said printer interface is installed in a slot of said printer, said printer interface and printer including non-volatile memory.
